(19) United States
(12) Patent Application Publication
(10) Pub. No.: US 2026/0270417 A1
(43) Pub. Date: Sep. 10, 2026

(54) TEMPLATE-BASED FILTERING FOR INTER PREDICTION

(71) Applicant: InterDigital CE Patent Holdings, SAS, Paris (FR)

(72) Inventors: Karam NASER, Cesson-Sevigne (FR); Thierry DUMAS, Cesson-Sevigne (FR); Antoine ROBERT, Cesson-Sevigne (FR); Philippe BORDES, Cesson-Sevigne (FR)

(21) Appl. No.: 18/873,235

(22) PCT Filed: Jun. 22, 2023
(86) PCT No.: PCT/EP2023/067059

§ 371 Date: Dec. 9, 2024

(30) Foreign Application Priority Data
Jul. 1, 2022 (EP) 22305981.7

(51) Int. Cl. H04N 19/117; H04N 19/105; H04N 19/176; H04N 19/503

(52) U.S. Cl. CPC H04N 19/117; H04N 19/105; H04N 19/176; H04N 19/503

(57) ABSTRACT

In one implementation, the prediction of a block is filtered using a filter learned on a template. To learn the filter, a first template is generated from a set of decoded samples in an area neighboring to the current block, and a second template is generated from a set of predicted samples in the same neighboring area, where the set of predicted samples can be obtained based on the prediction parameters used to predict the current block or from stored prediction samples for neighboring block(s) associated with the template area. The filter parameters are calculated by minimizing a loss function between the set of decoded samples and a set of filtered predicted samples. The filter can be a convolutional 7-tap filter, a convolution 5-tap filter, or a piecewise linear function.

### TECHNICAL FIELD

The present embodiments generally relate to a method and an apparatus for inter prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to one embodiment, a method of video decoding is presented, comprising: obtaining one or more prediction parameters for a block to be decoded in a picture; obtaining a prediction block for said block based on said one or more prediction parameters; obtaining a set of decoded samples in an area neighboring to said block; obtaining a set of predicted samples in said area neighboring to said block; obtaining one or more filter parameters for a filter based on said set of decoded samples and said set of predicted samples in said area neighboring to said block; applying said filter to said prediction block for said block to form a filtered prediction block for said block; and decoding said block based on said filtered prediction block for said block.

According to another embodiment, a method of video encoding is presented, comprising: obtaining one or more prediction parameters for a block to be encoded in a picture; obtaining a prediction block for said block based on said one or more prediction parameters; obtaining a set of decoded samples in an area neighboring to said block; obtaining a set of predicted samples in said area neighboring to said block; obtaining one or more filter parameters for a filter based on said set of decoded samples and said set of predicted samples in said area neighboring to said block; applying said filter to said prediction block for said block to form a filtered prediction block for said block; and encoding said block based on said filtered prediction block for said block.

According to another embodiment, an apparatus for video decoding is provided, comprising one or more processors and at least one memory coupled to said one or more processors, wherein said one or more processors are configured to: obtain one or more prediction parameters for a block to be decoded in a picture; obtain a prediction block for said block based on said one or more prediction parameters; obtain a set of decoded samples in an area neighboring to said block; obtain a set of predicted samples in said area neighboring to said block; obtain one or more filter parameters for a filter based on said set of decoded samples and said set of predicted samples in said area neighboring to said block; apply said filter to said prediction block for said block to form a filtered prediction block for said block; and decode said block based on said filtered prediction block for said block.

According to another embodiment, an apparatus for video encoding is provided, comprising one or more processors and at least one memory coupled to said one or more processors, wherein said one or more processors are configured to: obtain one or more prediction parameters for a block to be encoded in a picture; obtain a prediction block for said block based on said one or more prediction parameters; obtain a set of reconstructed samples in an area neighboring to said block; obtain a set of predicted samples in said area neighboring to said block; obtain one or more filter parameters for a filter based on said set of reconstructed samples and said set of predicted samples in said area neighboring to said block; apply said filter to said prediction block for said block to form a filtered prediction block for said block; and encode said block based on said filtered prediction block for said block.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates template matching performed on a search area around the initial MV.

FIG. 5 illustrates top and left neighboring blocks used in CIIP (Combined Inter and Intra Prediction) weight derivation.

FIG. 6A and FIG. 6B illustrate the division method for angular modes.

FIG. 7 illustrates input to the spatial 5-tap component of the filter when CCCM (Convolutional Cross-Component Model) predicts the current chrominance CB to be encoded/decoded from the potentially downsampled version of the reconstructed luminance CB that is collocated with the current chrominance CB.

FIG. 8A illustrates a reconstructed luminance CB that is collocated with the current W×H chrominance CB to be encoded/decoded, FIG. 8B illustrates the downsampled reconstructed luminance CB and the luminance reference area, and FIG. 8C illustrates its chrominance reference area.

FIG. 9A and FIG. 9B illustrate respectively the template of decoded reference samples and template of predicted samples of the current W×H luminance CB to be encoded/decoded.

FIG. 10 illustrates template-based filtering of the prediction on the encoder side, for the current block predicted in the inter mode, according to an embodiment.

FIG. 11 illustrates template-based filtering of the prediction on the decoder side, for the current block predicted in the inter mode, according to an embodiment.

### DETAILED DESCRIPTION

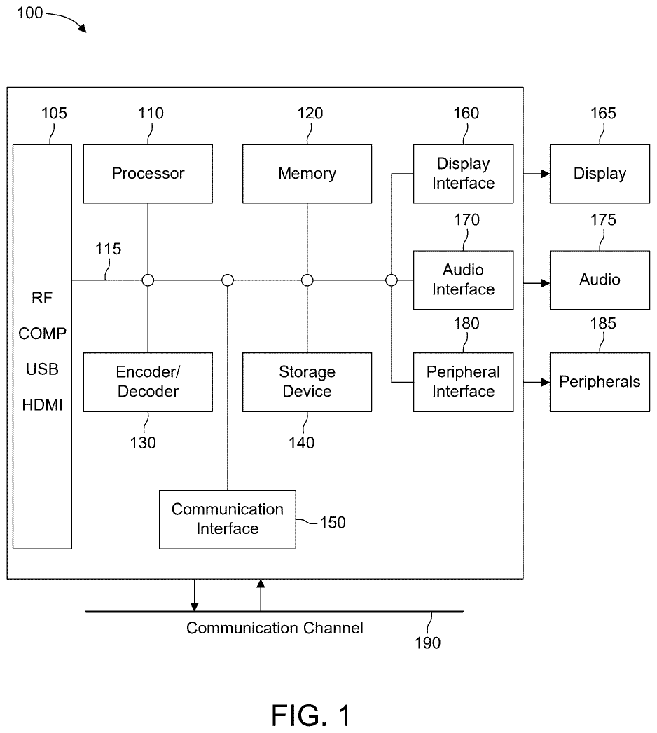

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

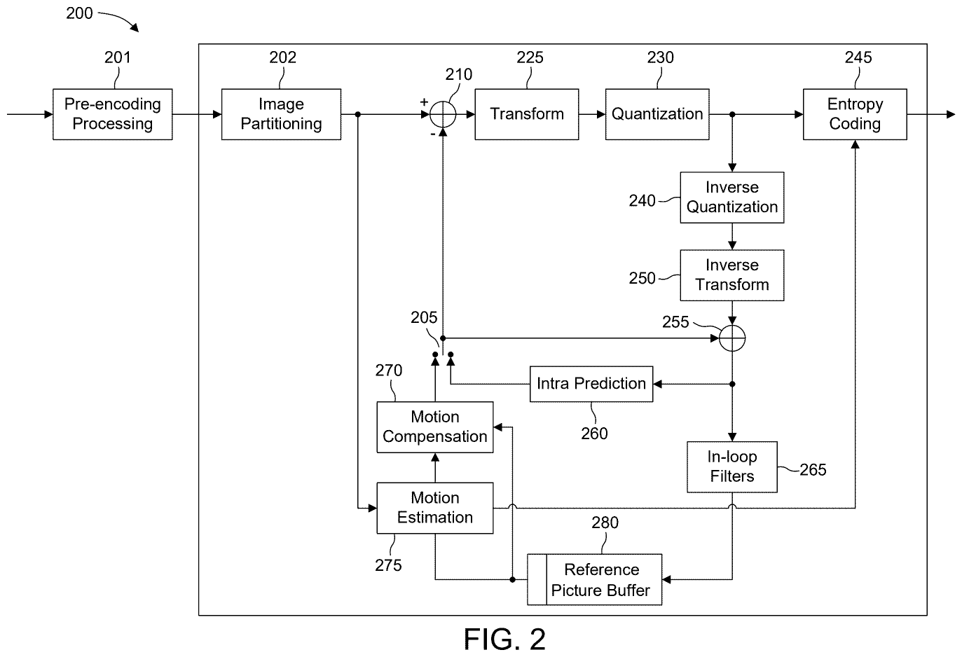

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

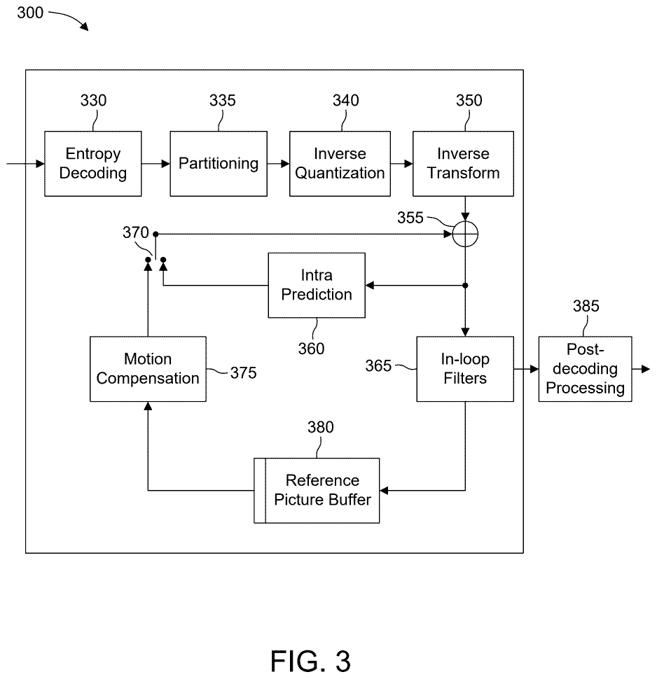

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information.

The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

This disclosure relates to inter coding. We propose to apply a filtering process to the prediction signal to improve the prediction and thus reduce the residual information signaled to the decoder side. The filter coefficients are learned from reconstructed neighboring samples, where no extra signaling is required as the same process is performed at both encoder and decoder sides. In the following, some details about inter coding in Enhanced Compression Model (ECM) and Versatile Video Coding (VVC) are presented.

Local illumination compensation (LIC) in ECM

LIC is an inter prediction technique to model local illumination variation between a current block and its prediction block as a function of that between a current block template and reference block template. The parameters of the function can be denoted by a scale α and an offset β, which form a linear equation, that is, α*p[x]+β to compensate illumination changes, where p[x] is a reference sample pointed to by the MV (Motion Vector) at a location x in a reference picture. Since α and β can be derived based on the current block template and reference block template, no signaling overhead is required for them, except that an LIC flag is signaled for AMVP (Advanced Motion Vector Prediction) mode to indicate the use of LIC.

The local illumination compensation is used for uni-prediction inter CUs with the following modifications.
Both Inter and Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC (Motion Compensation) with the block MV (Motion Vector) without rounding it to integer-pel precision.

### Template Matching (TM) in ECM

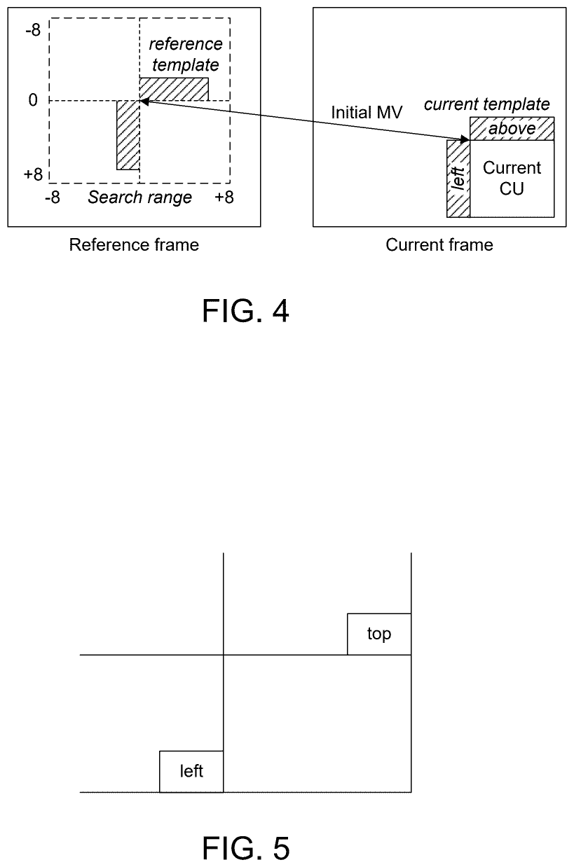

Template Matching (TM) is a decoder-side MV derivation method to refine the motion information of the current CU by finding the closest match between a template (i.e., top and/or left neighbouring blocks of the current CU) in the current picture and a block (i.e., same size as the template) in a reference picture. As illustrated in FIG. 4, a better MV is searched around the initial motion of the current CU within a pel search range (e.g., [−8, +8]-pel search range). In ECM, the template matching method is used with the search step size being determined based on AMVR (Adaptive Motion Vector Resolution) mode and TM can be cascaded with bilateral matching process in merge modes.

In AMVP mode, an MVP (Motion Vector Predictor) candidate is determined based on template matching error, where the one with the minimum difference between the current block template and the reference block template is selected. Then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

TABLE 1
Search patterns of AMVR and merge mode with AMVR.

| | AMVR mode | | | | Merge mode | |
|---|---|---|---|---|---|---|
| Search pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, a similar search method is applied to the merge candidate indicated by the merge index. As Table 1 shows, TM may perform all the way down to ⅛-pel MVD precision or skip those beyond half-pel MVD precision, depending on whether the alternative interpolation filter (that is used when AMVR is of half-pel mode) is used according to merged motion information. Besides, when the TM mode is enabled, template matching may work as an independent process or an extra MV refinement process between block-based and subblock-based bilateral matching (BM) methods, depending on whether BM can be enabled or not according to its enabling condition check.

### Combined Inter and Intra Prediction (CIIP) in VVC and ECM

In VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode, and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 5) as follows:
If the top neighbor is available and intra coded, then set isIntraTop to 1, otherwise set isTntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2.$$

In ECM, CIIP is extended in the following manner. The prediction samples are generated by weighting an inter prediction signal predicted using CIIP-TM merge candidate and an intra prediction signal predicted using TIMD (Template-based Intra Mode Derivation) derived intra prediction mode. The method is only applied to coding blocks with an area less than or equal to 1024.

The TIMD derivation method is used to derive the intra prediction mode in CIIP. Specifically, the intra prediction mode with the smallest SATD (Sum of Absolute Transformed Differences) values in the TIMD mode list is selected and mapped to one of the 67 regular intra prediction modes.

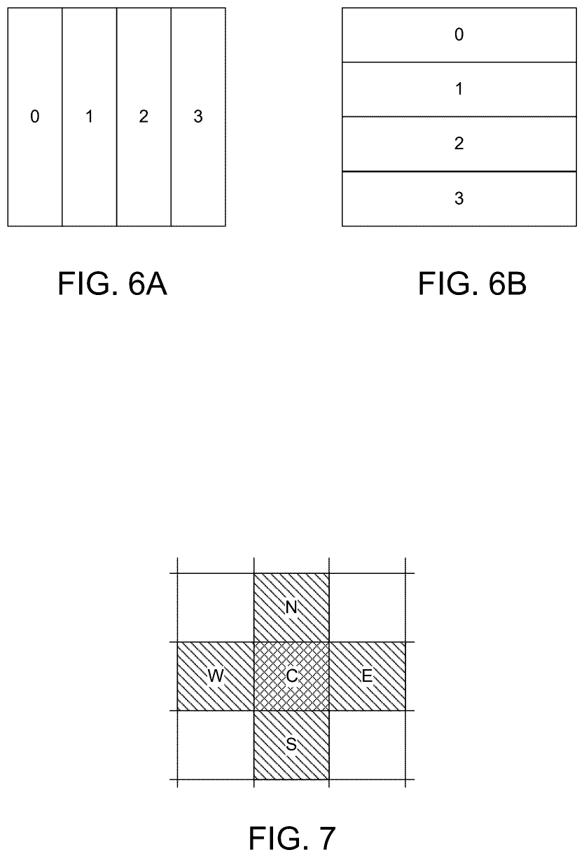

In addition, it is also proposed to modify the weights (wIntra, wInter) if the derived intra prediction mode is an angular mode. For near-horizontal modes (2≤angular mode index <34), the current block is vertically divided as shown in FIG. 6A; for near-vertical modes (34≤angular mode index ≤66), the current block is horizontally divided as shown in FIG. 6B.

The (wIntra, wInter) for different sub-blocks are shown in Table 2.

TABLE 2
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC (Adaptive Reordering of Merge Candidate) method as regular merge candidates. Basically, when ARMC is used, the merge candidates with less template distance to the current block template are put on top of the list. The maximum number of CIIP-TM merge candidates is equal to two.

### Convolutional Cross-Component Model (CCCM) in ECM

In the Exploration Experiment (EE) on top of ECM-4.0, the Convolutional Cross-Component Model (CCCM) predicts the current chrominance CB to be encoded/decoded by applying a convolutional filter to the potentially downsampled version of the reconstructed luminance CB that is collocated with the current chrominance CB. When using chroma sub-sampling, this downsampling is carried out such that the resolution of the downsampled collocated reconstructed luminance CB matches the resolution of the chroma grid.

The CCCM convolutional 7-tap filter consists of a 5-tap plus sign shape spatial component, a nonlinear term, and a bias term. The input to the spatial 5-tap component of the filter consists of a center (C) luma sample that is collocated with the current chroma sample to be predicted and its above/north (N), below/south (S), left/west (W), and right/east (E) neighbors, as shown in FIG. 7.

The nonlinear term P is represented as power of two of the center luma sample C and scaled to the sample value range of the content

$$P = ( C * C + midVal ) >> bitDepth$$

where bitDepth represents the pixel bit depth, and midVal represents the middle value of the bit depth range. For instance, for 10-bit content, it is calculated as

$$P = ( C * C + 5 \; 12 ) >> 10.$$

The bias term B represents a scalar offset between the input and output. B is set to the middle chroma value, e.g., 512 for 10-bit content. Calling c₀, c₁, c₂, c₃, c₄, c₅, and c₆ the seven coefficients of the 7-tap filter, the current predicted chroma sample “predChromaVal” is expressed as:

$$predChromaVal = clip ( {c}_{0} C + {c}_{1} N + {c}_{2} S + {c}_{3} E + {c}_{4} W + {c}_{5} P + {c}_{6} B )$$

where “clip” clips to the range of valid chroma sample values.

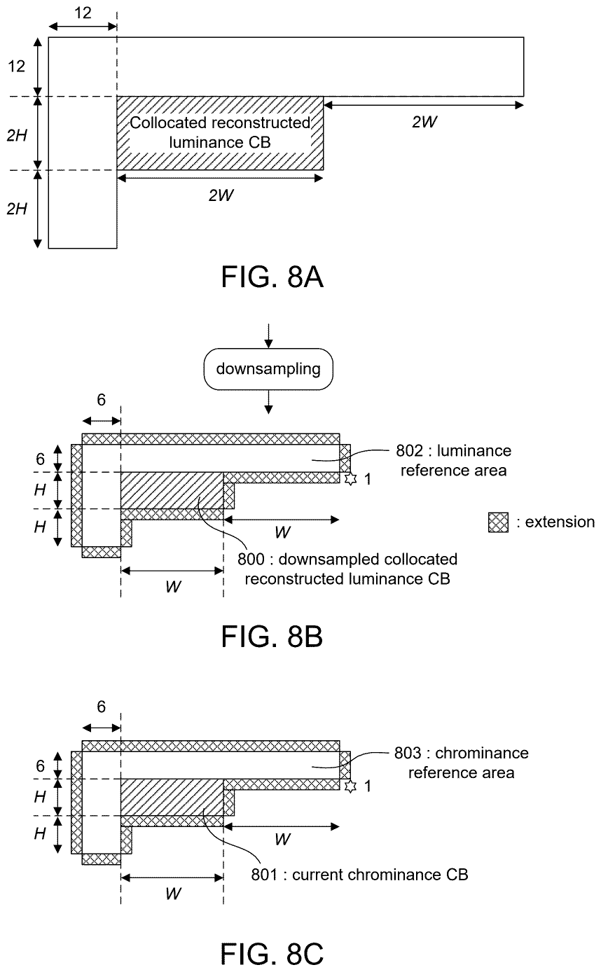

The filter coefficients c₀, c₁, c₂, c₃, c₄, c₅, and c₆ are calculated by minimizing the Mean Squared Error (MSE) between the predicted chroma samples generated by applying the convolutional 7-tap filter to the potentially downsampled version of the reconstructed luma samples in the luminance reference area (802) and the reconstructed chroma samples in the chrominance reference area (803) as shown in FIG. 8B and FIG. 8C.

FIG. 8A illustrates the reconstructed luminance CB that is collocated with the current W×H chrominance CB (801) to be encoded/decoded. FIG. 8B illustrates the downsampled reconstructed luminance CB (800) that is collocated with this chrominance CB, and the luminance reference area (802) in the case of chroma format 4:2:0, i.e., before encoding, the resolution of each chrominance channel is divided by 2 via sub-sampling. FIG. 8C illustrates its chrominance reference area (803).

The luminance reference area (802) consists of six rows/columns of potentially downsampled reconstructed luma samples above and on the left side of the potentially downsampled version of the reconstructed luminance CB (800) that is collocated with the current chrominance CB. The chrominance reference area (803) consists of six rows/columns of reconstructed chroma samples above and on the left side of the current chrominance CB (801) to be encoded/decoded. Each reference area extends one CB width to the right and one CB height below the CB boundaries. Each reference area is adjusted to include only available decoded reference samples. The extensions to the areas are needed to support the side samples of the plus shaped spatial filter and are padded when in unavailable areas.

The MSE minimization is performed by calculating an autocorrelation matrix for the luma input and a cross-correlation vector between the luma input and chroma output. The autocorrelation matrix is LDL decomposed and the final filter coefficients are calculated using back-substitution (matrix inversion). The process follows the calculation of the Adaptive Linear Filtering (ALF) filter coefficients in ECM, except that LDL decomposition is chosen instead of Cholesky decomposition to avoid using square root operations. The calculation uses only integer arithmetic.

Note that a single model or multi-model variant of CCCM can be used. The multi-model variant uses two models, one model derived for samples above the average luma reference value and another model for the rest of the samples. Multi-model CCCM mode can be selected for Coding Units (CUs) containing at least 128 available decoded reference samples.

Note also that the term “reference area” has been chosen to match the standard nomenclature of CCCM. But a reference area of a given CB is equivalent to the template of this CB.

In many ECM tools, the improvement of compression compared to VVC comes from the idea of selecting the coding mode implicitly, for example by performing RD (Rate-Distortion) search at both encoder and decoder sides. The advantage of such methods is to reduce the signaling overhead, where no syntax elements are required to describe the results of RD search. For example, in the TM process, where the motion vectors are refined around the current value using template comparison and selecting the motion vector that minimizes the difference between template prediction and the reconstructed template. No signaling is required since the decoder performs the same operation.

In this document, it is proposed to apply a filter to improve the inter prediction quality. This filter is learned from neighboring reconstructed samples, where no syntax elements are required to describe the filter at the decoder side. The filtering operation can be considered as an improvement to the LIC process, where LIC can be seen as a filter that considers only the central pixel in the convolutional shape depicted in FIG. 7. The proposed new filter may take into account the current central pixel as well as its surrounding pixels, similar to CCCM.

### Filtering of Luma Inter Prediction Learned on the Template

For a given W×H luminance CB to be encoded/decoded and predicted via a given inter prediction mode, the proposed filtering of the prediction of this CB via this inter prediction mode is decomposed into two steps: the learning of the filter and the application of the learned filter to the prediction of this CB. It should be noted that the proposed method of filtering of inter prediction can also be applied to the chroma components.

### Learning the Filter

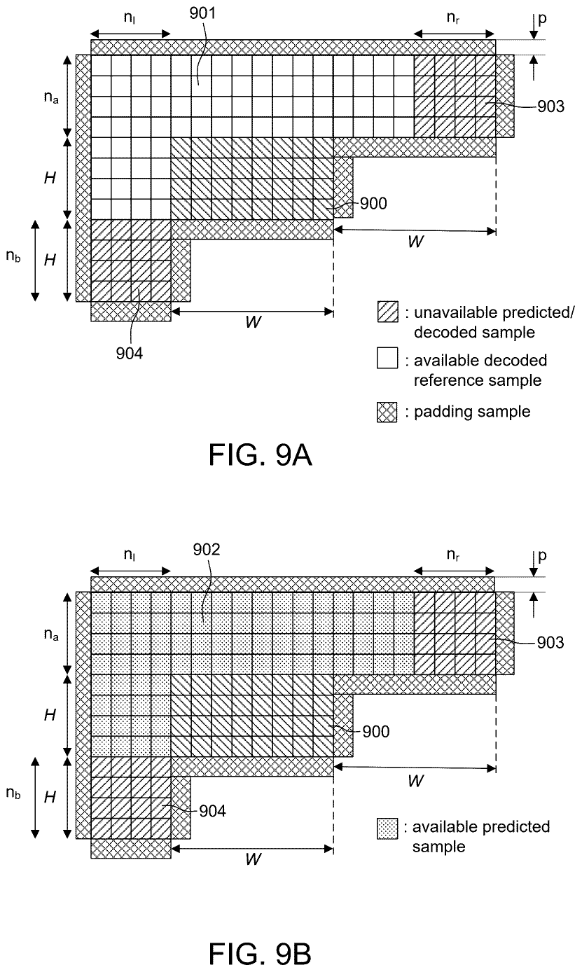

FIG. 9A and FIG. 9B illustrate template of predicted samples (902) and template of decoded reference samples (301) of the current W×H luminance CB (900) to be encoded/decoded.

The current W×H luminance CB (900) in FIG. 9A has a first template (901) in FIG. 9B, made of nₐ rows of reconstructed reference samples located above the current luminance CB and nₗ columns of reconstructed reference samples located on the left side of the current luminance CB. The current luminance CB also has a second template, (902) in FIG. 9B, made of nₐ rows of predicted samples located above the current luminance CB and nₗ columns of predicted samples located on the left side of the current luminance CB. The predicted samples are built using same parameters as for building the current CB prediction. Non-limiting examples of the prediction parameters to build the predicted samples include MV, merge index, reference picture information, affine parameters, AMVR parameters. To save the computation, the predicted samples may be the actual predicted samples (generated using the prediction parameters for the neighboring block) stored during reconstructing/decoding the template area.

Given the encoding/decoding partitioning history leading to the encoding/decoding of the current luminance CB, the first template (901) of decoded reference samples may be adjusted such that the unavailable reconstructed reference samples are excluded from (901). The second template (902) of predicted samples may be adjusted the same way, i.e., the unavailable predicted samples are excluded from (902). For instance, in FIG. 9A, the template (901) is adjusted to exclude the n_{b}∈[0, H] rows (904) of unavailable decoded reference samples at its bottom and the nᵣ∈[0, W] columns (903) of unavailable reconstructed reference samples at its right-hand side. Similarly, the template (902) is adjusted to exclude the n_{b}∈[0, H] rows (904) of unavailable predicted samples at its bottom and the nᵣ∈[0, W] columns (903) of unavailable predicted samples at its right-hand side. In general, the first template (901) of decoded reference samples and the second template (902) of predicted samples cover the same area in a picture.

Then, different possible filter parameters are tested to select the filter parameters θ. In particular, a possible filter parameter is applied to the second template of the predicted samples. The difference (e.g., MSE) between the filtered predicted samples and the decoded reference samples is calculated. The filter parameters θ may be learned by minimizing the MSE between the filtered luma samples in the template of predicted samples (902) and the reconstructed reference samples in the template of reconstructed reference samples (901). If needed, the template of reconstructed reference samples (901) and the template of predicted samples (902) may be padded the same way, using a padding border of p pixels. The padding may consist in filling the padding area with a given value. Alternatively, the padding may consist in copying into a given sample to be padded the value of an available spatially neighboring sample.

### Application of the Filter to the Prediction of the Current Luminance CB

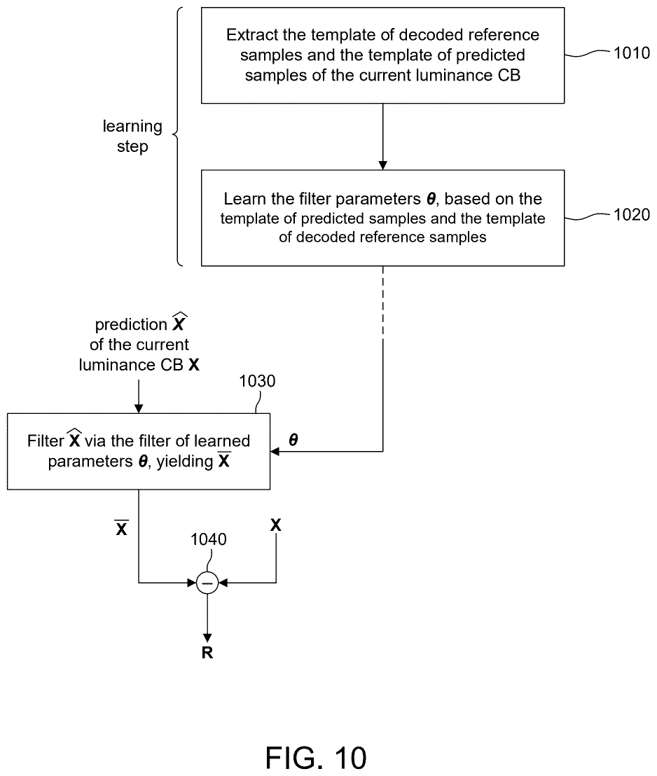

The filter of learned parameters θ may apply to the inter predicted block. FIG. 10 illustrates template-based filtering of the prediction on the encoder side, for the current block predicted in an inter mode, according to an embodiment.

In FIG. 10, the dotted line indicates that, on the encoder side, the learning step must be carried out before running the filtering of the prediction of the current luminance CB but not necessarily right before. Indeed, several processes may be placed between the learning step and the filtering of the prediction of the current luminance CB. For instance, as soon as the template of decoded reference samples is reconstructed for the current luminance CB, the learning step may be done.

In particular, at step 1010, the encoder extracts the template of decoded reference samples from the neighboring reconstructed regions of the current block, and the encoder also obtains the template of predicted samples for the current block. At step 1020, based on the template of decoded reference samples and the template of predicted samples, the filter parameters θ is learned.

As described above, the predicted samples in the second template can be generated by using the prediction parameters for the current block. Alternatively, to save computation, the predicted samples may be extracted from the template area, namely, the predicted samples (based on the prediction parameters used to encode/decode a neighboring block) for the neighboring block are stored and can be extracted directly to be used in the second template.

Then, the filtering of the current luminance CB may be performed (1030) on the prediction \hat{X} of the current block, yielding the filtered prediction X̅. The difference between the filtered prediction (X̅) and the original block (X) is calculated (1040) to obtain the prediction residuals. The residuals can then be quantized, transformed and entropy coded as illustrated in FIG. 2.

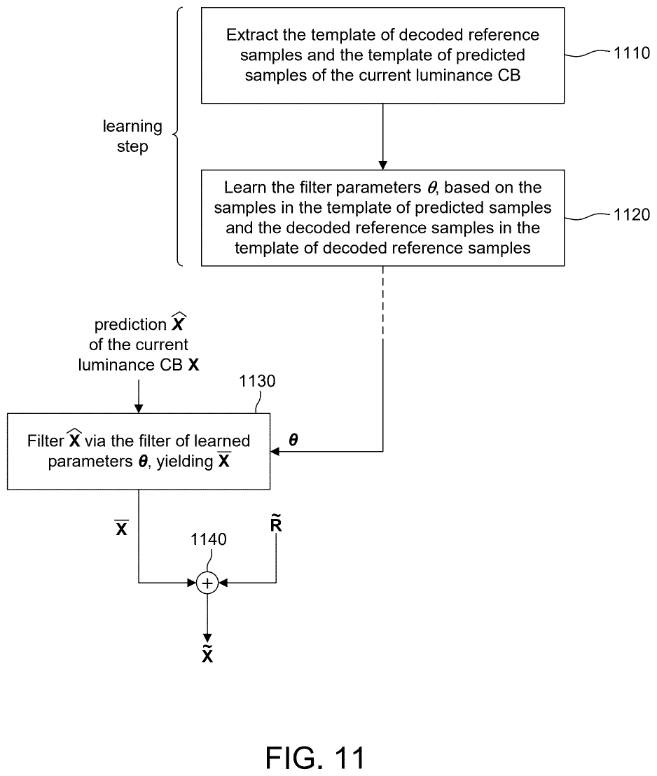

FIG. 11 illustrates template-based filtering of the prediction on the decoder side, for the current luminance CB predicted in the inter mode, according to an embodiment.

Similar to the encoder side, in FIG. 11, the dotted line indicates that, on the decoder side, the learning step must be carried out before launching the filtering of the prediction of the current luminance CB but not necessarily right before.

In particular, at step 1110, the decoder extracts the template of decoded reference samples from the neighboring decoded regions of the current block, and the decoder also obtains the template of predicted samples for the current block. The templates are generated in the same manner as in the encoder side. At step 1120, based on the template of decoded reference samples and the template of predicted samples, the filter parameter θ is learned (1120).

Then, the filtering of the current luminance CB may be performed (1130) on the prediction \hat{X} of the current block, yielding the filtered prediction X̅. The reconstructed residue (\tilde{R}) of the current luminance CB, coming from the inverse transform, is combined (1140) with the filtered prediction (X̅) to form the reconstructed current luminance CB (\tilde{X}). The reconstructed block can be further filtered as illustrated in FIG. 3.

Filter being a Convolutional 7-Tap Filter as in CCCM

The filter may be a convolutional 7-tap filter as in CCCM. In this case, the input to the spatial 5-tap component of the filter may consist of a center (C) luma predicted sample and its above/north (N), below/south (S), left/west (W), and right/east (E) neighbors. Moreover, θ={c₀, c₁, c₂, c₃, c₄, c₅, c₆}. The definitions of the non-linear term and the bias term may follow those described with respect to CCCM. Any other definition for the non-linear term or the bias term may also apply.

Filer being a Convolutional 5-Tap Filter

The filter may be a convolutional 5-tap filter. This case may amount to the case presented with respect to CCCM, but removing the non-linear term and the bias term. θ={c₀, c₁, c₂, c₃, c₄}.

Filter being a Piecewise Linear Function

The filter may be a piecewise linear function ƒ with p∈ [symbol] * pieces. Note that, as a piecewise linear function may be expressed under different forms, its set of parameters may take different forms. For instance, a piecewise linear function may be expressed by giving the linear piece of index i a slope αᵢ and an offset βᵢ and pre-defining its bounds (bᵢ, bᵢ₊₁). In this case, θ={(αᵢ, βᵢ)}_{i∈[0,ρ-1]}. For instance, if ρ=4, b₀=0, b₁=120, b₂=570, b₃=1003, b₄=1024, for a given input predicted luma sample x and its output filtered version \tilde{x},

$$\tilde{x} = f ( \overline{x} ; θ ) = \{ \begin{matrix}{α}_{0} \overline{x} + {β}_{0} & if \overline{x} ∈ [ 0 , 120 ) \\ {α}_{1} \overline{x} + {β}_{1} & if \overline{x} ∈ [ 120 , 570 ) \\ {α}_{2} \overline{x} + {β}_{2} & if \overline{x} ∈ [ 570 , 1003 ) \\ {α}_{3} \overline{x} + {β}_{3} & if \overline{x} ∈ [ 1003 , 1024 )\end{matrix}$$

In this example, the selection of the filter parameters θ is function of the sample value to be filtered (x), but it may be a locally pre-filtered value for example (this may have advantage to de-noise before applying f( ) or responsive to local gradient activity as proposed in JVET-Z0140 (see an article by Che-Wei Kuo et al., “AHG12: Enhanced CCLM”, JVET-Z0140, 26th JVET Meeting, by teleconference, 20-29 Apr. 2022).

Interaction with LIC

As described earlier, LIC can be considered as a special case of the proposed idea where the filter is a single-tap filter. That is, the central pixel is filtered (multiplied) and a shift is added.

In one embodiment, LIC can be replaced by the proposed filtering operation. The advantage of this method is that no additional flag is needed to indicate that the filter is being used since the LIC flag is repurposed to indicate that a filtering operation is performed.

Interaction with TM

In TM, the best motion is found via minimizing the distance (e.g., SSD, SAD, SATD) between the prediction block template and the current block template. The TM mode can be further improved by learning the best filter parameters after the template matching operation. That is, the filtering operation is constantly performed for TM mode. This leads to a new mode, named template matching plus filtering (TM+filtering), which does not require further signaling as the TM flag is repurposed to indicate TM+filtering.

### CIIP and GPM Interaction

In CCIP, a combined prediction is generated from both inter and intra parts. This combined prediction requires specific consideration for computing the filter coefficients. The same is true for Geometric Prediction Mode (GPM) when one part is predicted by intra and the other by inter. The following options are considered:
1. A single filter is learned for the inter part, the intra prediction is not filtered.
2. Two separate filters are learned for inter and intra parts, both prediction signals are filtered.
3. Disable filtering process for these modes.

### Bidirectional and Multi Hypothesis Interaction

Similar to the previous embodiment, when bidirectional prediction or multi-hypothesis is used, a combination of prediction signal is performed. The following options are considered:
1. Multiple separate filters are learned for each prediction signal, both prediction signals are filtered with separate filters.
2. One single filter applied on the final prediction signal.
3. Disable filtering process for these modes.

In the above, we describe our proposed methods mainly with respect to a coding unit or a coding block. It should be noted that the proposed methods can be applied at other partition levels or block levels where inter prediction is used.

### Filtering Parameters Computation for Merge Mode

In the case of merge mode, instead of using the templates of the current block and the reference block for computing the filter parameters, another method is proposed. Basically, the merge mode refers to another coding block that is predicted with the same motion information as compared to the current block. Therefore, it can be assumed that the statistics of the prediction/reconstructed signal of the two blocks (current and merge block) are similar. It is then more sensible to obtain the filter parameters that minimize the distance between the prediction signal and the reconstructed signal of the merge block (i.e., the merge block is the template area). The filter is used then to improve the prediction of the current block. It should be noted that this process is done at both encoder and decoder sides, where the merge block is available at both sides.

In the case of subblock transform (SBT), where the inter predicted block is divided into two subblocks with a pre-defined transform pair, the filtering operation can be modified as follows: the filter parameters are computed from the first partition (namely, the first partition is used as the template for the send partition) and applied to the next partition. This is because both partitions have the same prediction and therefore it can be assumed that both have similar statistics. It should be noted that this process is done at both encoder and decoder sides, where the merge block is available at both sides.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 375), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
obtaining one or more prediction parameters for a block to be decoded in a picture;
obtaining a prediction block for said block based on said one or more prediction parameters;
obtaining a set of decoded samples in an area neighboring to said block;
obtaining a set of predicted samples in said area neighboring to said block;
obtaining one or more filter parameters for a filter based on said set of decoded samples and said set of predicted samples in said area neighboring to said block;
applying said filter to said prediction block for said block to form a filtered prediction block for said block; and
decoding said block based on said filtered prediction block for said block.

2. (canceled)

3. The method of claim 1, wherein said set of predicted samples is obtained based on said one or more prediction parameters for said block.

4. The method of claim 1, wherein said set of predicted samples is obtained based on predicted samples stored from decoding one or more neighboring blocks associated with said template area.

5. The method of claim 1, wherein said one or more filter parameters are obtained by minimizing a loss function between said set of decoded samples and a filtered version of said set of predicted samples in said area neighboring to said block.

6-9. (canceled)

10. The method of claim 1, wherein said one or more prediction parameters include at least a motion vector, reference picture information, merge mode information, and AMVR (Adaptive Motion Vector Resolution) information.

11. The method of claim 1, wherein a flag is used to indicate that template matching is used for prediction, and wherein said flag also indicates that said filter is applied.

12. The method of claim 1, further comprising:
obtaining another prediction for said block, wherein said another prediction is filtered with another filter different than said filter.

13. The method of claim 1, further comprising:
obtaining another prediction for said block; and
combining said prediction and said another prediction for said block to form a multi-hypothesis prediction for said block, wherein said multi-hypothesis prediction is filtered with said filter.

14. The method of claim 12, wherein said another prediction for said block is obtained from intra prediction, or from a geometric prediction mode.

15. The method of claim 1, wherein a neighboring merge block is selected as a template area.

16. An apparatus for video decoding, comprising one or more processors and at least one memory, wherein said one or more processors are configured to:
obtain one or more prediction parameters for a block to be decoded in a picture;
obtain a prediction block for said block based on said one or more prediction parameters;
obtain a set of decoded samples in an area neighboring to said block;
obtain a set of predicted samples in said area neighboring to said block;
obtain one or more filter parameters for a filter based on said set of decoded samples and said set of predicted samples in said area neighboring to said block;
apply said filter to said prediction block for said block to form a filtered prediction block for said block; and
decode said block based on said filtered prediction block for said block.

17. (canceled)

18. The apparatus of claim 16, wherein said set of predicted samples is obtained based on said one or more prediction parameters for said block.

19. The apparatus of claim 16, wherein said set of predicted samples is obtained based on predicted samples stored from decoding one or more neighboring blocks associated with said template area.

20. The apparatus of claim 16, wherein said one or more filter parameters are obtained by minimizing a loss function between said set of decoded samples and a filtered version of said set of predicted samples in said area neighboring to said block.

21. The apparatus of claim 16, wherein said one or more processors are further configured to:
obtain another prediction for said block, wherein said another prediction is filtered with another filter different than said filter.

22. The apparatus of claim 16, wherein a neighboring merge block is selected as a template area.

23-24. (canceled)

25. A method of video encoding, comprising:
obtaining one or more prediction parameters for a block to be encoded in a picture;
obtaining a prediction block for said block based on said one or more prediction parameters;
obtaining a set of decoded samples in an area neighboring to said block;
obtaining a set of predicted samples in said area neighboring to said block;
obtaining one or more filter parameters for a filter based on said set of decoded samples and said set of predicted samples in said area neighboring to said block;
applying said filter to said prediction block for said block to form a filtered prediction block for said block; and
encoding said block based on said filtered prediction block for said block.

26. The method of claim 25, wherein a neighboring merge block is selected as a template area.

27. An apparatus for video encoding, comprising one or more processors and at least one memory, wherein said one or more processors are configured to:
obtain one or more prediction parameters for a block to be encoded in a picture;
obtain a prediction block for said block based on said one or more prediction parameters;
obtain a set of decoded samples in an area neighboring to said block;
obtain a set of predicted samples in said area neighboring to said block;
obtain one or more filter parameters for a filter based on said set of decoded samples and said set of predicted samples in said area neighboring to said block;
apply said filter to said prediction block for said block to form a filtered prediction block for said block; and
encode said block based on said filtered prediction block for said block.

28. The apparatus of claim 27, wherein a neighboring merge block is selected as a template area.
